(19) United States
(12) Patent Application Publication
(10) Pub. No.: US 2015/0120940 A1
(43) Pub. Date: Apr. 30, 2015

(54) APPARATUS AND METHOD FOR CHANGING RESOURCE USING PATTERN INFORMATION, AND RECORDING MEDIUM USING THE SAME

(71) Applicant: SAMSUNG SDS CO., LTD., Seoul (KR)

(72) Inventors: Sung Duck KIM, Seoul (KR); Gi Duk PARK, Seoul (KR); Byoung Soo KIM, Seoul (KR); Jae Jeong KIM, Seoul (KR)

(73) Assignee: SAMSUNG SDS CO., LTD., Seoul (KR)

(21) Appl. No.: 14/527,966

(22) Filed: Oct. 30, 2014

(30) Foreign Application Priority Data
Oct. 31, 2013 (KR) 10-2013-0130939

(51) Int. Cl. H04L 12/927

(52) U.S. Cl. CPC H04L 47/80
USPC 709/226

(57) ABSTRACT

Provided is an apparatus for determining whether to change resources using pattern information. The apparatus includes a reception unit which receives resource information which is information about an amount of resources used of a plurality of servers which exist in a data center which provides resources to a user, a basic data generation unit which generates basic data about predetermined items in preset time units using the resource information, a pattern information generation unit which generates pattern information using the basic data, and a resource change determination unit which determines whether to increase, maintain, or reduce the resources using the generated pattern information.

### CROSS-REFERENCE TO RELATED APPLICATION

This application claims priority from Korean Patent Application No. 10-2013-0130939 filed on Oct. 31, 2013 in the Korean Intellectual Property Office, and all the benefits accruing therefrom under 35 U.S.C. 119, the contents of which in its entirety are herein incorporated by reference.

### BACKGROUND

1. Field of the Invention

The inventive concept relates to an apparatus and method for changing a resource using pattern information, and a recording medium using the same, and more particularly, to an apparatus and method for changing a resource using pattern information which determines reduction, maintenance, and increase which are provided in a data center, and a recording medium using the same.

2. Description of the Related Art

A server usage-based charge system is a scheme that charges fees according to the amount of use of the resources such as a CPU and a memory of a server which is installed in a data center.

In a data center that uses a usage-based charge system, it is important to accurately determine whether to increase, maintain, or reduce resources at the current point of time for the server. When there come to be extra resources due to inaccurate judgment on whether to reduce the resources at the current point of time for the server operated by the data center, unnecessary investment and management costs for the extra resources may be generated.

Further, if the data center fails to accurately determine whether to increase the resources at the current point of time for the server operated by the data center, the response speed of the server drops.

The response decrease not only is a matter of performance deterioration, but also can affect the service provided to users by occurrence of various errors.

According to the existing method which manages servers which provide resources to the user, the threshold for the amount of use of the resources is predetermined, and when the data collected at regular intervals exceeds by more than a predetermined number of times, the resources may be added by being selected as a subject for resource increase.

Further, according to the existing method which manages servers which provide resources to the user, if the average of the amount of use of resources is preset threshold or higher, the resources may be added by being selected as a subject for resource increase.

According to such existing methods, the increase or reduction of resources was performed based on a simple arithmetic value such as the number or times of exceeding the threshold or the average, and thus even when there is no influence to the service provided to the user, the resources have been increased, thereby generating unnecessary costs, or service stability has been influence due to resource reduction.

Further, in the case of the servers which provide resources to the user, thousands to millions of servers are often managed, and one person is often in charge of tens or hundreds of servers, and thus it is difficult to efficiently manage and analyze the resource use rate, and whether to increase or decrease the resources.

### SUMMARY

The inventive concept includes an apparatus and method for determining whether to change resources using pattern information which generates basic data by using resource information of each server of a data center and generates pattern information which may be used in increasing or reducing resources provided in the data center.

Further, the present invention further provides an apparatus and method for determining whether to change resources using pattern information which automatically increases or reduces resources without a manger's intervention by using generated pattern information.

Further, the present invention further provides an apparatus and method for providing generated pattern information and information on whether to change resources to a manger.

In accordance with an aspect of the present invention, an apparatus for determining whether to change resources using pattern information includes: a reception unit which receives resource information which is information about an amount of resources used of a plurality of servers which exist in a data center which provides resources to a user; a basic data generation unit which generates basic data about predetermined items in preset time units using the resource information; a pattern information generation unit which generates pattern information using the basic data; and a resource change determination unit which determines whether to increase, maintain, or reduce the resources using the generated pattern information.

In accordance with another aspect of the present invention, a method of determining whether to change resources using pattern information includes: receiving resource information which is information about the amount of resources used of a plurality of servers which exist in a data center which provides resources to a user; generating basic data about predetermined items in preset time units using the resource information; generating pattern information using the basic data; and determining whether to increase, maintain, or reduce the resources using the generated pattern information.

In accordance with another aspect of the present invention, a computer-readable recording medium has recorded thereon a program for: receiving resource information which is information about an amount of resources used of a plurality of servers which exist in a data center which provides resources to a user; generating basic data about predetermined items in preset time units using the resource information; generating pattern information using the basic data; and determining whether to increase, maintain, or reduce the resources using the generated pattern information.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram of an apparatus for determining whether to change resources using pattern information according to an embodiment of the present invention;

FIG. 2 illustrates an example of basic data which is generated by a basic data generation unit;

FIG. 3 is a block diagram of an example of a pattern information generation unit;

FIG. 4 is a flowchart illustrating a method of determining whether to change resources by using pattern information according to an embodiment of the present invention;

FIG. 5 is a flowchart illustrating an example of a detailed operation of an operation (S430) of generating pattern information using standardized resource information by a pattern information generation unit;

FIG. 6 is a flowchart illustrating an example of a detailed operation of an operation (S431) of generating pattern information about whether there is an abnormal value by a first pattern information generation unit;

FIG. 7 is a flowchart illustrating an example about a detailed operation of an operation (S433) of generating used amount trend pattern information by periods by a third pattern information generation unit;

FIG. 8 is a flowchart illustrating an operation of using information determined in an operation (S440) which determines whether to change resources by using pattern information; and

FIG. 9 is a flowchart illustrating an operation of using pattern information and information determined in an operation (S440) which determines whether to change resources by using pattern information.

### DETAILED DESCRIPTION OF THE EMBODIMENTS

Hereinafter, exemplary embodiments of the present invention will be described with reference to the attached drawings. The advantages and features of the inventive concept and methods for achieving them will become clear by referring to the attached drawings and the embodiments which are described later in detail. However, the present invention is not limited to the embodiments which are disclosed below, but the present invention may be implemented in various other forms. The embodiments are provided to complete the disclosure of the present invention and to let one of ordinary skill in the art clearly understand the scope of the invention, and the present invention is defined by the scope of claims. The same reference numerals refer to the same components throughout the specification.

The expression “connected” or “linked” implies that one component is connected or linked directly to another component, but there may be further another component between the components. However, the expression “directly connected” or “directly linked” implies that there is not further another component between the components.

Unless defined otherwise, all the terms used in the present specification (including technical and scientific terms) may be used as meanings which may be commonly understood to one of ordinary skill in the art. Further, the terms which are defined in a generally used dictionary are not ideally or excessively understood unless specially defined. In the present specification, a singular form also includes a plural form unless specially mentioned. The terms “comprise” and/or “comprising” used in the specification do not exclude the existence or addition of one or more components, steps, operations, and/or devices other than the mentioned components, steps, operations, and/or devices.

The present invention relates to a technology for managing a lot of servers which exist in a data center which provides resources to a user by using a server usage-based charge system, etc.

Specifically, the present invention relates to a technology which determines whether to increase or reduce resources based on the amount of resources used and manages servers according to the determined resource increase or reduction.

One of technical features of the present invention is to determine whether to increase, maintain, or reduce resources based on the amount of resources used.

That is, the present invention provides patterned information on the resource amount used to a manager of a data center or servers, thereby helping the manager to make a decision on whether to increase or reduce resources.

Further, the present invention may automatically perform operation and management such as a resource change by using patterned information.

The details about the present invention will now be described with reference to the attached drawings.

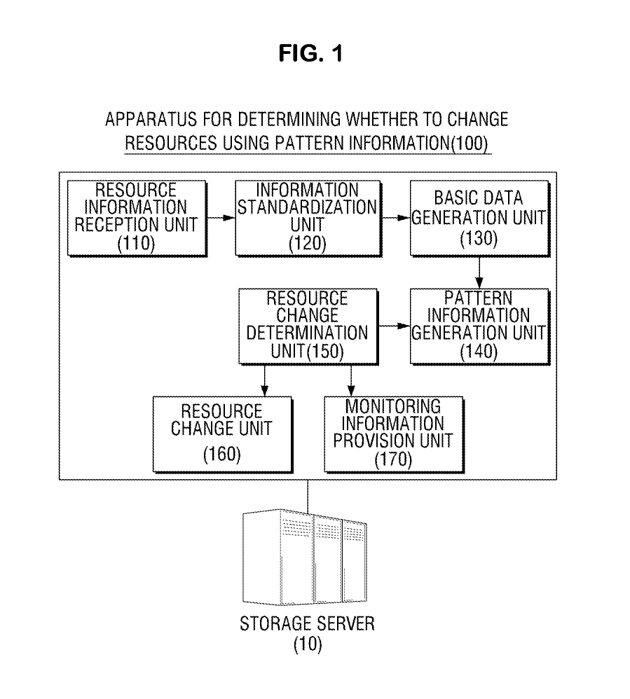

FIG. 1 is a block diagram of an apparatus for determining whether to change resources using pattern information according to an embodiment of the present invention.

Referring to FIG. 1, an apparatus 100 for determining whether to change resources using pattern information according to an embodiment of the present invention includes a resource information reception unit 110, an information standardization unit 120, a basic data generation unit 130, a pattern information generation unit 140, a resource change determination unit 150, a resource change unit 160, and a monitoring information provision unit 170.

A storage server 10 may be included in the apparatus 100 for determining whether to change resources using pattern information according to the embodiment of the present invention, and may exist as a separate server.

The resource information reception unit 110 may receive resource information which is information about the resource amount used of a lot of servers which exist in the data center.

The resource information reception unit 110 may directly receive resource information from each server and may receive resource information stored in the storage server 10.

The storage server 10 may collect resource information of each server for each predetermined period such as a second, a minute, or 5 minutes, and the resource information reception unit 110 may receive resource information stored in the storage server 10.

The resource information may mean information related to resources such as the CPU amount used, input/output amount, disk amount used, and memory amount used.

A raw data format of resource information may be a server name, a date, a resource type, and an amount used.

An information standardization unit 120 may standardize resource information received by the resource information reception unit 110 for each server.

Information related to CPU among resource information received by the resource information reception unit 110 may have the same type standard data as that of the raw data, and thus the standardization process may not be needed, but because the format and unit for the time used or the amount used are generally different for each server, the standardization process may be needed.

The resource information standardized by the information standardization unit 120 may be stored in the storage server 10.

The storage server 10 may be a server which stores mass data such as a Hadoop distributed file system (HDFS). There may be thousands or even millions of servers in the data center, and the resource information which is generated from such many servers becomes mass data. Hence, it is necessary for the storage server 10 to safely store mass data. The HDFS basically provides a triple backup, and thus the possibility of a data loss decreases.

Further, the storage server 10 may store mass resource information or standardized resource information in the HDFS of Hadoop in order to perform a distributed parallel process for a quick process of mass data.

The HDFS is used as an example of the storage server 10, but the embodiment is not limited thereto. As another example of the storage server 10, Linux, Java, etc. may be used for a distributed parallel process in a general standalone server. The basic data generation unit 130 may generate predetermined basic data about predetermined items in time units (Time 1) by using resource information.

The resource information which is used in generating basic data by the basic data generation unit 130 may be resource information received by the resource information reception unit 110 or resource information stored in the storage server 10.

Specifically, the basic data generation unit 130 may generate basic data by using resource information which has been standardized by using resource information by the information standardization unit 120 or resource information stored in the storage server 10.

Basic data about the predetermined items are generated based on preset time units (Time 1) and may include the total number of the standardized resource information data sets, the average value of the amount of the standardized resources used, the maximum value of the amount of the standardized resources used, the minimum value of the amount of the standardized resources used, the number of cases where there is an abnormal value in the amount of the standardized resources used, and the average of information excluding the abnormal values from the amount of standardized resources used, and the peak value among the information excluding the abnormal values from the amount of the resources used.

A case where the amount of resources used exceeds a predetermined threshold (Th 1), this may be considered as an abnormal value.

The predetermined threshold (Th 1) may be set according to the current resource provision possible state, etc.

Generating based on predetermined time units (Time 1) may mean generating basic data such as the total number of the standardized resource information data sets, the average of the amount of the standardized resources used, and the maximum of the amount of the standardized resources used in 10 minute units when the preset time unit is 10 minutes. The time unit (Time 1) may be set according to the type of the server, the number of servers, the load of the resource information collection, the accuracy of the result drawn according to the resource information, or the number of users who use the service provided by the data center, and may be changed by the manager.

The basic data generation unit 130 may generate basic data from standardized resource information by utilizing a program such as a map reduce which allows a distributed, parallel process. There is a high possibility that the standardized resource information is mass data, and the basic data generation unit 130 may enhance the generation speed through a distributed, parallel process of basic data.

Further, basic data about predetermined items for each standardized resource information set may be generated.

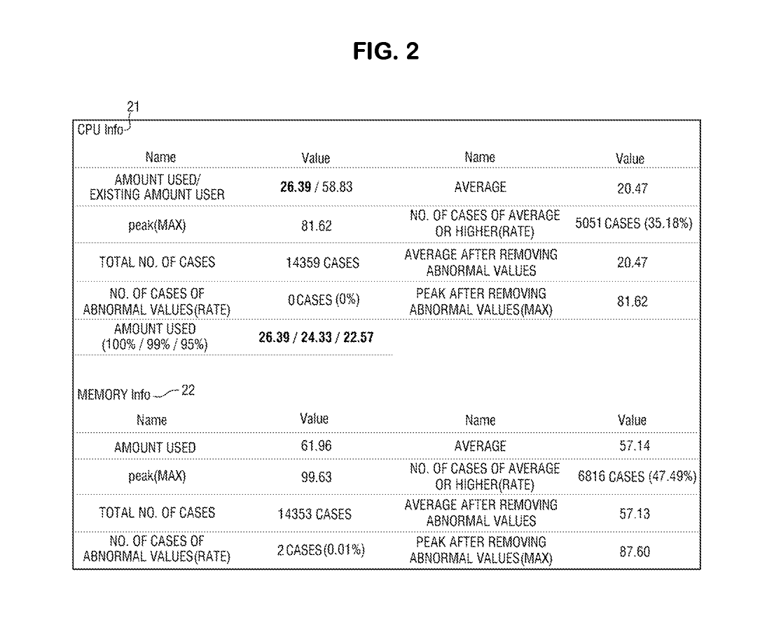

FIG. 2 illustrates an example of basic data which is generated by a basic data generation unit.

FIG. 2 illustrates an example where basic data is generated by the basic data generation unit 130 in two parts which are CPU resource information 21 and memory resource information 22.

Further, the basic data generation unit 130 shows the amount used/the basic amount used, peak (max value), the total number of cases, the number of abnormal cases (ratio), the amount used (100%/99%/95%), the average value, the number of cases higher than the average (ratio), the average after removing abnormal values, and the values about peak (max value) items after removing abnormal values which are specific basic data about predetermined items of the CPU resource information 21.

Further, the basic data generation unit 130 shows the amount used/the basic amount used, peak (max value), the total number of cases, the number of abnormal cases (ratio), the amount used (100%/99%/95%), the average value, the number of cases higher than the average (ratio), the average after removing abnormal values, and the values about peak (max value) items after removing abnormal values which are specific basic data about predetermined items of the memory resource information 22.

The pattern information generation unit 140 may generate pattern information by using basic data generated by the basic data generation unit 130.

Specifically, the pattern information generation unit 140 may generate at least one of pattern information on about whether there is an abnormal value of the amount of resources used, periodically repeated pattern information and, trend pattern information on the amount used by periods.

Further, when the pattern information generation unit 140 generates basic data and pattern information using predetermined various conditions, the pattern information generation unit 140 may set the corresponding code name for each generated pattern information set according to the presetting.

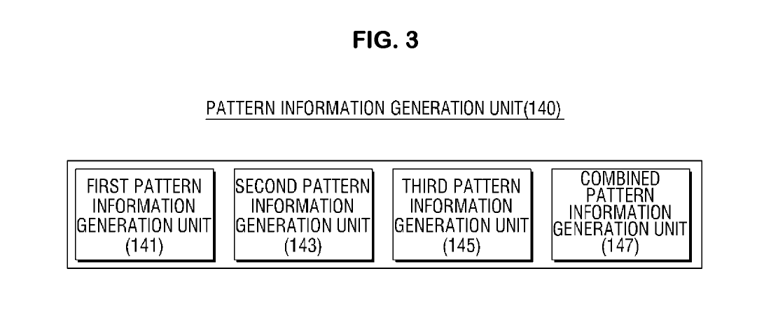

The pattern information generation unit 140 will now be described in detail with reference to FIG. 3.

FIG. 3 is a block diagram of an example of a pattern information generation unit.

Referring to FIG. 3, the pattern information generation unit 140 includes a first pattern information generation unit 141, a second pattern information generation unit 143, a third pattern information generation unit 145, and a combined pattern information generation unit 147.

The first pattern information generation unit may generate pattern information on whether there is an abnormal value by using the basic data which is generated by the basic data generation unit.

Specifically, the first pattern information generation unit 141 may analyze the number of cases where there is an abnormal value by preset time intervals (period 1) by using basic data, and may generate pattern information about whether there is an abnormal value by using the preset condition of the number of abnormal values and the preset number of cases by time intervals (period 1).

The preset time interval (period 1) may be changed according to the service quality intended to be provided to the user, the number of servers, and the manager's setting. For example, 6 hours, 1 day, 1 week, and 1 month interval time intervals may be set.

The preset condition of the number of types of abnormal values (Number 1) may be set according to the service quality, the server type, the accuracy of the result drawn according to the resource information, or the number of users who use the service provided by the data center, or may be changed by the manager. For example, the number may be set to 5, 10, 20, etc.

The second pattern information generation unit 143 may determine whether a predetermined repetition condition (resource threshold 1, for example, abbreviated as RT1) is satisfied for a specified period of time by using basic data which is generated by a basic data generation unit 130 and thereby generate information on whether the predetermined repetition condition RT1 is satisfied and periodic repetition pattern information about the number of times of satisfying the condition.

The periodic repetition pattern information generated by the second pattern information generation unit 143 may be pattern information for recognizing the situation and characteristics of the server and the resource by determining whether the generation of the abnormal values of more than a certain number is repeated under the same condition in periodic units such as repetition by days, weeks, and months.

As an example of a preset repetition condition RT1 for a specific period of time, the case where abnormal values occur predetermined three or more times between 2 to 4 pm every day may be set as a condition, and the second pattern information generation unit 143 may analyze data which satisfies the condition RT1 which is set for each day by using the basic data, and generate pattern information.

Further, as another example of a preset repetition condition RT1 for a specific period of time, the case where abnormal values occur preset 10 or more times every Friday may be set as a condition, and the second pattern information generation unit 143 may analyze data which satisfies the condition RT1 for each week by using the basic data and generate pattern information.

Further, as another example of a preset repetition condition RT1 for a specific period of time, the case where abnormal values occur preset 10 or more times 25th of every month may be set as a condition, and the second pattern information generation unit 143 may analyze data which satisfies the condition RT1 for each month by using the basic data and generate pattern information.

The periodic repetition pattern information generated by the second pattern information generation unit 143 may include information on the number of times of satisfying the preset repetition condition.

Specific examples of the preset repetition condition RT1 for a specific period of time are merely examples for better understanding of the present invention, but the present invention is not limited thereto.

The second pattern information generation unit 143 may separate data which satisfies the preset condition RT1 which is set by days, weeks, or months so as to set the preset code name.

If the third pattern information generation unit 145 receives an input on the period during which a search by a manager is desired, the third pattern information generation unit 145 may generate trend pattern information on the amount of resources used by periods regarding whether the amount of resources during the period is on the increase or on the decrease.

Specifically, the third pattern information generation unit 145 may generate trend pattern information on the amount of resources used by periods by using the basic data and the preset trend type condition.

The preset trend type condition may set the standard for determining the trend of the amount of resources used by using the basic data for a period during which a search by a manger is desired.

Trend pattern information for the amount of resources used by periods may be generated by using the predetermined trend type condition and basic data. For example, if the average increases by 10% or more every month for a desired period of time (e.g., 3 months), and the average of the final month exceeds 80% of the preset threshold, trend pattern information on the amount of resources used by periods which indicates that the resources need to be added may be generated.

If the average increases by 10% or more every month, but the average of the final month is less than 80% of the preset threshold, trend pattern information on the amount of resources used by periods which indicates that the resources does not need to be added may be generated.

The 80% of the preset threshold may refer to 80% of x if the preset threshold is x.

On the other hand, if the average decreases by 10% or more every month and the average of the final month is less than 20% of the preset threshold, trend pattern information on the amount of resources used by periods which indicates that the resources need to be reduced may be generated. If the average decreases by 10% or more every month, but the average of the final month is 20% or more of the preset threshold, trend pattern information on the amount of resources used by periods which indicates that the resources does not need to be reduced may be generated.

Further, when the resource variance of each month is less than 5%, the trend pattern information on the amount of resources used for each period which indicates the resources need to be maintained unchanged may be generated.

Such a predetermined trend type condition may be changed according to the desired period, the service quality of the data center, the stability of resource provision, and the number of servers.

As a specific example of generating trend pattern information on the amount of resourced used by periods by the third pattern information generation unit 145, if the amount of resources for recent three months is 60%, 66%, and 70%, the pattern information may be generated as the increasing trend of 10% increase and 5% increase. The information generated according to the setting of the predetermined trend type condition may become different. If the predetermined trend type condition is the increasing trend and 80% of the preset threshold is, for example, 74%, it may be understood that the resources need to be added. Then if the amount of resources used for the recent three months is 60%, 66%, and 70%, the third pattern information generation unit 145 may generate the trend pattern information on the amount of resources used by periods indicating that the trend is on the increase, but the resources do not need to be added.

If the recent three month amount of resources used is 60%, 66%, and 73%, the third pattern information generation unit 145 may generate the trend pattern information on the amount of resources used by periods indicating that the trend is on the increase and the resources need to be added. If the 80% of the preset threshold is 74%, the third pattern information generation unit 145 may generate trend pattern information on the amount of resources used by periods indicating that the trend is on the increase, but the resources do not need to be added.

As described above, numerical values of predetermined trend type conditions may be changed by various situations and policies such as the system environment, manager's setting, service quality, and the user increase.

The combined pattern information generation unit 147 may generate pattern information by combining pattern information which is generated by the first pattern information generation unit 141, the second pattern information generation unit 143, and the third pattern information generation unit 145.

Specifically, in the combined pattern information generation unit 147, the pattern information, which is generated by the first pattern information generation unit 141, the second pattern information generation unit 143, and the third pattern information generation unit 145, may be coded after each code name is set, and a new code may be set by combining coded information.

The information generated by the pattern information generation unit 140 may be stored in the storage server 10.

Referring to FIG. 1, the resource change determination unit 150 may determine whether to increase, maintain, or reduce the resources by using the pattern information generated by the pattern information generation unit 140.

When the resource increase or reduction is determined by the resource change determination unit 150, the resources may be increased or reduced according to the determination of the resource change determination unit 150 without intervention of the manager of the server or datacenter.

That is, if the decision of the resource change determination unit 150 is to increase the resources at the current point of time, the resource change unit 160 may increase resources without intervention of the manager at the current point of time.

On the other hand, if the decision of the resource change determination unit 150 is to reduce resources at the current point of time, the resource change unit 160 may reduce resources without intervention of the manager at the current point of time.

The monitoring information provision unit 170 may provide at least one of the pattern information generated by the pattern information generation unit 140 and the information determined by the resource change determination unit 150 to the manager.

Further, the monitoring information provision unit 170 may provide information desired by the manager from among pattern information generated by the pattern information generation unit 140 and the information determined by the resource change determination unit.

The manager may finally decide whether to increase or reduce resources by using information which is provided from the monitoring information providing unit 170 according to what was requested by the manager himself or information which is automatically provided to the manager by the monitoring information providing unit 170 according to what has been set in advance, so as to increase or reduce the resources.

The apparatus 100 of determining whether to change resources by using pattern information according to an embodiment of the present invention may not include at least one of the resource change unit 160 and the monitoring information providing unit.

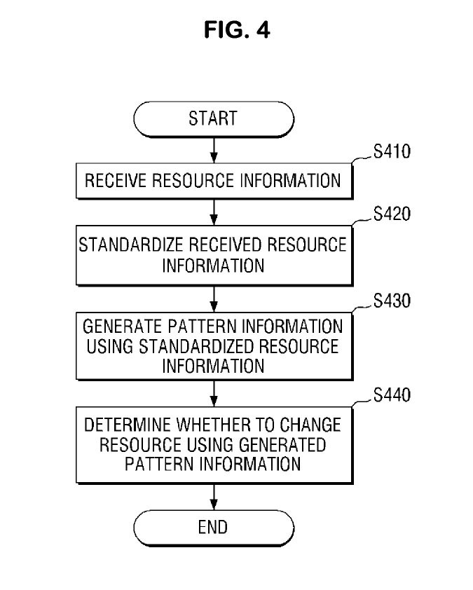

FIG. 4 is a flowchart illustrating a method of determining whether to change resources by using pattern information according to an embodiment of the present invention.

Referring to FIG. 4, according to a method of determining whether to change resources by using pattern information according to an embodiment of the present invention, the resource information reception unit 110 may receive resource information of each server which exists in the data center (S410).

The information standardization unit 120 may standardize resource information (S420).

The pattern information generation unit 140 may generate pattern information by using standardized resource information (S430).

The resource change determination unit 150 may determine whether to change the resources by using pattern information (S440).

A specific example of the operation (S430) of generating pattern information by the pattern information generation unit 140 by using standardized resource information will be described.

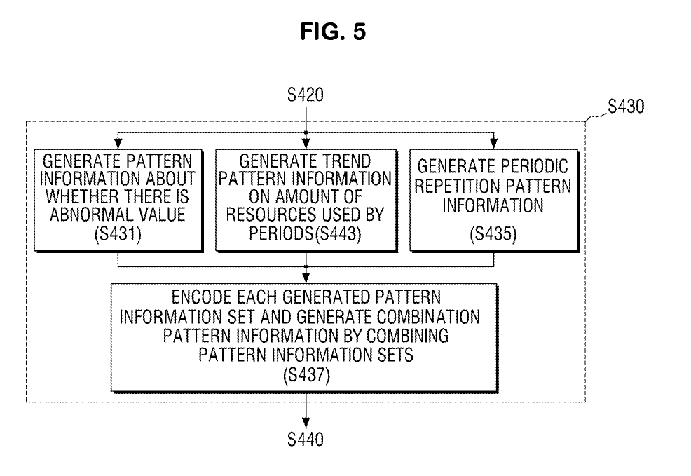

FIG. 5 is a flowchart illustrating an example of a detailed operation of an operation (S430) of generating pattern information using standardized resource information by a pattern information generation unit.

Referring to FIG. 5, the operation S430 may include an operation of generating pattern information about whether there is an abnormal value by the first pattern information generation unit 141 (S431), an operation of generating trend pattern information on the amount of resources used by periods (S433), an operation of generating periodic repetition pattern information by the second pattern information generation unit 143 (S435), and an operation of encoding each generated pattern information set and generating combination pattern information by combining pattern information sets (S437).

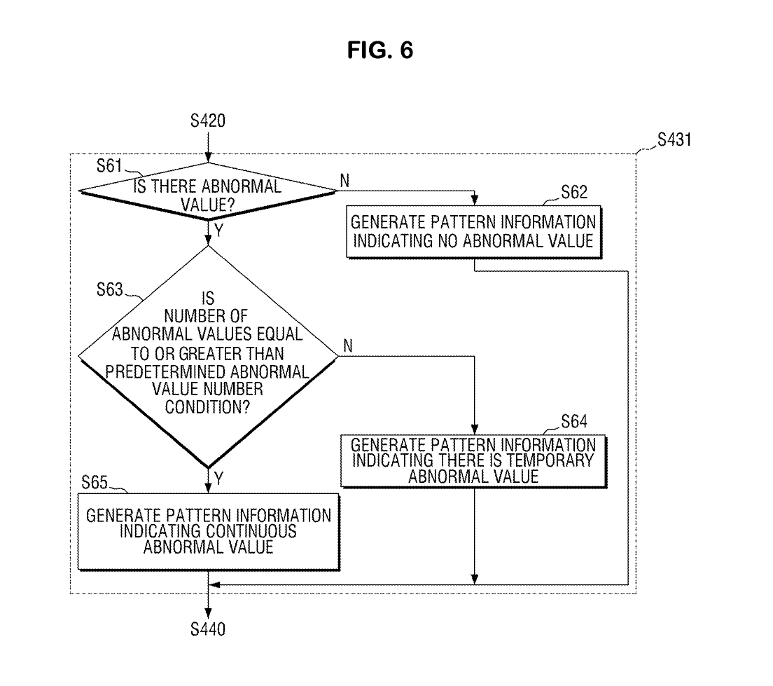

FIG. 6 is a flowchart illustrating an example of a detailed operation of an operation (S431) of generating pattern information about whether there is an abnormal value by a first pattern information generation unit.

Referring to FIG. 6, the first pattern information generation unit 141 may determine whether there is an abnormal value in the basic data which is generated by time intervals (S61), and if it is determined that there is no abnormal value, the pattern information indicating that there is no abnormal value may be generated (S62). Further, the first pattern information generation unit 141 may set a code name corresponding to the pattern information indicating no abnormal value.

The first pattern information generation unit 141 may generate pattern information (S63 and S64) indicating that there is a temporary abnormal value when there is an abnormal value and the number of abnormal values are less than a predetermined number (S63 and S64). Further, the first pattern information generation unit 141 may set a code name corresponding to the pattern information indicating that there is a temporary abnormal value.

When there are abnormal values and the number of abnormal values is a predetermined number or higher, the first pattern information generation unit 141 may generate pattern information indicating that there are continuous abnormal values (S63 and S65). Further, the first pattern information generation unit 141 may set a code name corresponding to the pattern information indicating continuous abnormal values.

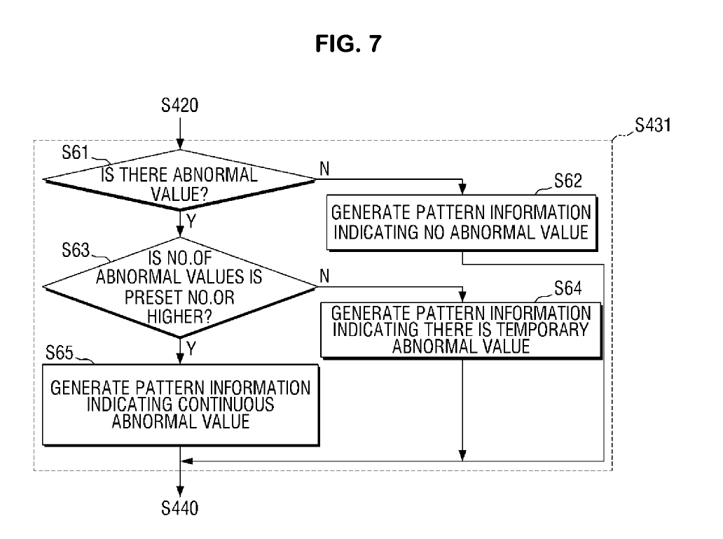

FIG. 7 is a flowchart illustrating an example about a detailed operation of an operation (S433) of generating used amount trend pattern information by periods by a third pattern information generation unit.

Referring to FIG. 7, the third pattern information generation unit 145 may receive a desired search period (S71) and generate the amount of resources used for the received period or obtain the generated basic data information (S72).

The third pattern information generation unit 145 may determine whether the amount of resources used for the desired search period is on the increase, according to the predetermined trend type condition (S73).

If it is determined that the amount is on the increase as a result of the determination in operation S73, the third pattern information generation unit 145 may generate pattern information related with the increasing trend (S74).

Further, if it is determined that the amount is not on the increase as a result of determination of the operation S73, the third pattern information generation unit 145 may determine whether the amount of resources used for the desired search period is on the decrease according to the predetermined trend type condition (S75).

If it is determined that the amount is on the decrease as a result of the determination of operation S75, the third pattern information generation unit 145 may generate pattern information related to the decreasing trend (S76).

On the other hand, if it is determined that the amount is not on the decrease as a result of the determination of S75, the third pattern generation unit 145 may generate pattern information related to the maintaining state.

The pattern information related to the increasing trend, the pattern information related to the decreasing trend, and the pattern information related to the maintaining trend generated by the third pattern information generation unit 145 may be specifically classified into the resource increase, resource reduction, and resource maintenance, etc. according to the predetermined type condition so that a code name may be set.

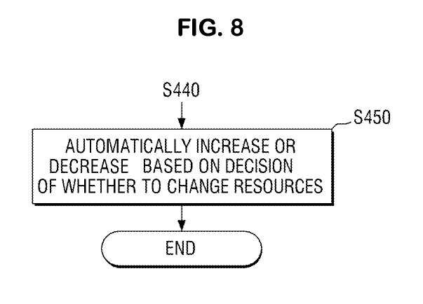

FIG. 8 is a flowchart illustrating an operation of using information determined in an operation (S440) which determines whether to change resources by using pattern information.

Referring to FIG. 8, in the method of determining whether to change resources using pattern information according to an embodiment of the present invention which has been described with reference to FIG. 4, an operation of automatically increasing or reducing the resources without the manager's intervention by the resource change unit 160 based on the result of determination by the resource change determination unit 150 (S450) may be further included.

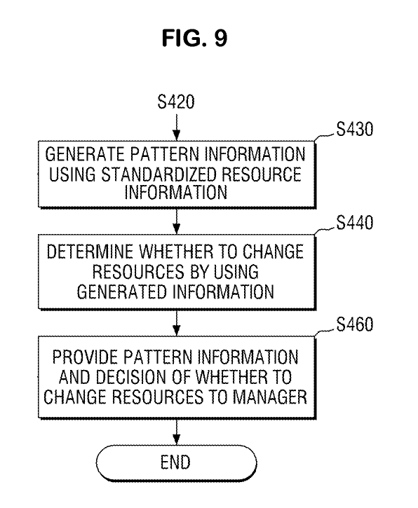

FIG. 9 is a flowchart illustrating an operation of using pattern information and information determined in an operation (S440) which determines whether to change resources by using pattern information.

Referring to FIG. 9, in the method of determining whether to change resources using pattern information according to an embodiment of the present invention which has been described with reference to FIG. 4, the operation S460 may be further included.

The operation S460 is an operation of providing, by the monitoring information provision unit 170, pattern information generated by the pattern generation unit and information on the decision on whether to change resources generated by the resource change determination unit 150 to devices such as a display device used by the manager.

The manager may determine whether to reduce, maintain, or increase resources by using pattern information and information on decision of whether to change resources.

The method of determining whether to change resources by using pattern information may be implemented as a computer-readable code in a computer-readable recording medium.

That is, the recording medium, on which a method of providing an update according to the present invention is implemented, may have recorded a program for performing a process of receiving resource information which is information on the amount of resources used of a plurality of servers existing in a data center which provides resources to the user, a process of generating basic data in predetermined time units using the resource information, a process of generating pattern information using the basic data, and a process of determining whether to increase, maintain, and reduce the resource by using the generated pattern information.

A computer-readable recording medium includes all kinds of recording media where data readable by a computer system is stored. Some examples of non-transitory computer-readable recording media are RAM, ROM, CD-ROM, a magnetic tape, an optical data storage device, and a floppy disk. Examples of a transitory computer readable medium include transmission through Internet and implementation in the form of a carrier wave.

Further, the computer-readable recording media are distributed to a computer system connected by a network, and computer-readable codes may be stored and executed in a distributed manner. Further, functional programs, codes, and code segments for implementing the recording method may be easily inferred by programmers in the art.

Each component of FIGS. 2 and 3 may refer to software, or hardware such as field-programmable gate array (FPGA) and application-specific integrated circuit (ASIC). However, the components are not limited to software or hardware. They may be configured to be in an addressable storage medium or may be configured to execute one or more hardware processors. The function provided in the components may be implemented by more segmented components and may combine a plurality of components so as to implement them as one component for performing a specific function.

According to the present invention, various pattern information which is useful in determining whether to reduce, maintain, or increase resources is generated, and thus resources may be efficiently managed.

According to the present invention, resources may be automatically managed by using pattern information.

According to the present invention, pattern information and information generated by using pattern information are provided to a manager, and thus the manager can easily recognize the current state of resources and the resources may be efficiently managed.

The embodiments of the present invention have been described above with reference to the attached drawings, but it may be understood by one of ordinary skill in the art that the present invention may be executed in other specific forms without changing the technical idea and essential features. Hence, it should be understood that the above-described embodiments are merely examples and do not limit the scope of the present invention.

What is claimed is:

1. An apparatus for determining whether to change resources, using pattern information, the apparatus comprising:
a reception unit configured to receive resource information including information about resource usage, of resources of a plurality of data center servers, allocated to a user;
a basic data generation unit configured to generate basic data about predetermined resource-related items, in preset time units, using the received resource information;
a pattern information generation unit configured to generate pattern information using the generated basic data; and
a resource change determination unit configured to make a resource change determination with respect to the resources, based on the generated pattern information;
wherein the resource change determination indicates whether to increase, maintain, or reduce the resources allocated to the user.

2. The apparatus of claim 1, wherein the pattern information generation unit comprises a first pattern information generation unit configured to analyze a number of instances in the basic data, of an abnormal value exceeding a preset threshold, by predetermined time intervals, and generate pattern information about whether an abnormal value is present based on the analyzed number of instances of the abnormal value and a predetermined abnormal value type number condition.

3. The apparatus of claim 2, wherein the first pattern information generation unit is further configured to generate pattern information indicating:
no abnormal value when no abnormal value is detected,
a temporary abnormal value when a number of abnormal values does not satisfy the predetermined abnormal value number condition, and
a continuous abnormal value when a number of abnormal values satisfies the predetermined abnormal value number condition.

4. The apparatus of claim 1, wherein the pattern information generation unit comprises a second pattern information generation unit configured to determine whether a predetermined repetition condition is satisfied for a specific period of time by using the basic data, configured to generate information on whether the predetermined repetition condition is satisfied, and configured to generate periodic repetition pattern information about a number of times the condition is satisfied.

5. The apparatus of claim 1, wherein the pattern information generation unit comprises a third pattern information generation unit configured to generate trend pattern information, on the amount of resources used by periods, about whether the amount of resources used is on the increase, is remaining unchanged, or is on the decrease for a user-indicated search period, wherein the trend pattern information is generated based on the basic data and on a predetermined trend type condition.

6. The apparatus of claim 5, wherein the pattern information generation unit further comprises:
a first pattern information generation unit configured to analyze a number of instances in the basic data, of an abnormal value exceeding a preset threshold, by predetermined time intervals, and generate pattern information about whether an abnormal value is present based on the analyzed number of instances of the abnormal value by the predetermined time intervals and a predetermined abnormal value type condition; and
a combined pattern information generation unit configured to generate combined pattern information from the generated pattern information and the trend pattern information.

7. The apparatus of claim 5, wherein the pattern information generation unit comprises:
a second pattern information generation unit configured to determine whether a predetermined repetition condition is satisfied for a specific period of time by using the basic data, configured to generate information on whether the predetermined repetition condition is satisfied, and configured to generate periodic repetition pattern information about a number of times the condition is satisfied; and
a combined pattern information generation unit configured to generate combined pattern information from the periodic repetition pattern information and the trend pattern.

8. The apparatus of claim 7, wherein the pattern information generation unit further comprises:
a first pattern information generation unit configured to analyze a number of instances in the basic data, of an abnormal value exceeding a preset threshold, by predetermined time intervals, and generate pattern information about whether an abnormal value is present based on the analyzed number of instances of the abnormal value by the predetermined time intervals and a predetermined abnormal value type condition,
wherein the combined pattern information generation unit generates the combined pattern information by combining pattern information about the abnormal value, trend pattern information on the amount of the resources used by periods, and the periodic repetition pattern information.

9. The apparatus of claim 1, wherein the apparatus further comprises a resource change unit configured to change the allocation of the resources to the user in response to the determination of the resource change determination unit.

10. The apparatus of claim 1, wherein the apparatus further comprises a monitoring information provision unit configured to output at least one of:
pattern information generated by the pattern information generation unit, and
information determined by the resource change determination unit.

11. The apparatus of claim 1, further comprising an information standardization unit configured to standardize the resource information received by the resource information reception unit, wherein the basic data generation unit generates the basic data based on the standardized resource information.

12. The apparatus of claim 11, wherein, for a distributed parallel process, the standardized resource information is distributed and stored.

13. The apparatus of claim 1, wherein the resource information received by the resource information reception unit includes, for each of the plurality of servers, at least one of: an amount of CPU used, an input/output amount, an amount of disk used, and an amount of memory.

14. The apparatus of claim 1, wherein the predetermined items include a total number of the resource information data, an average of the amount of resources used, a maximum of the amount of resources used, a minimum of the amount of resources used, a number of instances of the abnormal value, an average of the amount of resources used excluding the abnormal value, and data about at least one peak of the amount of resources used excluding the abnormal value.

15. The apparatus of claim 1, wherein the basic data generation unit is further configured to generate the basic data by processing the resource information in parallel.

16. A method of determining whether to change resources using pattern information, the method comprising:
receiving resource information including information about resource usage, of resources of a plurality of data center servers, allocated to a user;
generating basic data about predetermined resource-related items, in preset time units, using the received resource information;
generating pattern information using the generated basic data; and
making a resource change determination with respect to the resources, based on the generated pattern information, wherein the resource change determination indicates whether to increase, maintain, or reduce the resources allocated to the user.

17. The method of claim 16, wherein the generating of the pattern information comprises analyzing a number of instances in the basic data, of an abnormal value exceeding a preset threshold, by predetermined time intervals, and generating pattern information about whether an abnormal value is present based on the analyzed number of instances of the abnormal value and a predetermined abnormal value type number condition.

18. The method of claim 16, wherein the generating of the pattern information comprises
determining whether a predetermined repetition condition is satisfied for a specific period of time by using the basic data,
generating information on whether the predetermined repetition condition is satisfied, and
generating periodic repetition pattern information about a number of times of satisfying the condition.

19. The method of claim 16, wherein the generating of the pattern information comprises generating trend pattern information, on the amount of resources used by periods, about whether the amount of resources used is on the increase, is remaining unchanged, or is on the decrease for a user-indicated search period, wherein the trend pattern information is generated based on the basic data and on a predetermined trend type condition.

20. A computer-readable recording medium having recorded thereon a program for enabling a processor of a computer system to implement operations comprising:
receiving resource information including information about resource usage, of resources of a plurality of data center servers, allocated to a user;
generating basic data about predetermined resource-related items, in preset time units, using the received resource information;
generating pattern information using the generated basic data; and
making a resource change determination with respect to the resources, based on the generated pattern information, wherein the resource change determination indicates whether to increase, maintain, or reduce the resources allocated to the user.
